(19) United States
(12) Patent Application Publication
(10) Pub. No.: US 2023/0315059 A1
(43) Pub. Date: Oct. 5, 2023

(54) USER INTERFACE, METHOD AND HTML CODE FOR PARAMETERIZATION OF AN AUTOMATION UNIT

(71) Applicant: Siemens Aktiengesellschaft, München (DE)

(72) Inventor: Martin Herget, Erlangen (DE)

(21) Appl. No.: 18/024,794

(22) PCT Filed: Sep. 1, 2021
(86) PCT No.: PCT/EP2021/074074

§ 371 Date: Mar. 6, 2023

(30) Foreign Application Priority Data
Sep. 17, 2020 (DE) 10 2020 211 656.3

(51) Int. Cl. G05B 19/418

(52) U.S. Cl. CPC G05B 19/41835; G05B 2219/37084

(57) ABSTRACT

A user interface for parameterization of an automation unit; a display and a processor which is programmed to output a primary dialogue and secondary dialogues graphically on the display, the primary dialogue mapping to a basic function of the automation unit, and each secondary dialogue mapping to a following function which is necessary for performance of the basic function, and including interaction elements, by means of which the automation unit are parameterised so that the following function are performed, and for each secondary dialogue the primary dialogue provides a selection element, actuation of which enables the secondary dialogue in question to be accessed directly from the primary dialogue. The primary dialogue gives a user a work overview with familiar concepts of an application domain in the form of utility functions. This reduces the learning effort and mental strain when the user is performing the task.

### CROSS-REFERENCE TO RELATED APPLICATIONS

This application claims priority to PCT Application No. PCT/EP2021/074074, having a filing date of Sep. 1, 2021, which claims priority to DE Application No. 10 2020 211 656.3, having a filing date of Sep. 17, 2020, the entire contents both of which are hereby incorporated by reference.

### FIELD OF TECHNOLOGY

The following relates to intelligent automation units, for example inverters or drives, which are frequently equipped with a web server for communication with other systems. A user can then interact with the automation unit via web pages provided by the web server and, in particular, can parameterize the automation unit in the process.

### SUMMARY

An aspect relates to improve the parameterization of an automation unit.

The user interface for parameterizing an automation unit contains a display that is designed to output a graphical user interface, and a processor that is programmed to output a primary dialog and multiple secondary dialogs graphically on the display, wherein the primary dialog maps to a base function of the automation unit, for the performance of which the automation unit is designed, and wherein each secondary dialog maps to a follow-on function, which is necessary for performing the base function, and has interaction elements, via which the automation unit can be parameterized, whereby the follow-on function can be performed, and wherein the primary dialog provides, for each secondary dialog, a selection element, by actuating which the respective secondary dialog can be opened directly from the primary dialog. The user interface additionally contains at least one input means which allows operation of the selection elements and/or the interaction elements.

In the method for parameterizing an automation unit, a processor outputs a primary dialog graphically on a display, wherein the primary dialog maps to a base function of the automation unit, for the performance of which the automation unit is designed, and wherein the primary dialog provides, for each secondary dialog from a plurality of secondary dialogs, a selection element, by actuating which the respective secondary dialog can be opened directly from the primary dialog, and

wherein each secondary dialog maps to a follow-on function, which is necessary for performing the base function. In a selection step, the processor or a further processor detects an actuation of one of the selection elements by a user and outputs the selected secondary dialog graphically on the display. In a processing step, the processor or a further processor evaluates actuations of interaction elements in the selected secondary dialog by the user and parameterizes the automation unit accordingly, whereby the follow-on function of the selected secondary dialog is performed. The selection step and the processing step are repeated until all follow-on functions are performed, whereby the base function is performed.

The HTML code for parameterizing an automation unit is suitable for storage on a web server on the automation unit that is designed to communicate with a web client on a terminal device, and is suitable for execution in the web client and is additionally designed to output a primary dialog and multiple secondary dialogs graphically on a display of the terminal device, wherein the primary dialog maps to a base function of the automation unit, for the performance of which the automation unit is designed, and wherein each secondary dialog maps to a follow-on function, which is necessary for performing the base function, and has interaction elements, via which the automation unit can be parameterized, whereby the follow-on function can be performed. The primary dialog provides, for each secondary dialog, a selection element, by actuating which the respective secondary dialog can be opened directly from the primary dialog.

The processor is, for example, a microprocessor or microcontroller, a system-on-a-chip or a programmable digital component such as a “field programmable gate array” (FPGA).

The web client is, for example, a browser or a standalone application. The terminal device is, for example, a tablet, a smartphone, a notebook or a fixedly installed PC.

The automation unit is, for example, an automation component (such as an inverter, a drive or a controller), a machine, a group of automation components or machines, or an automated plant such as a factory or a power plant.

The display is a touchscreen, a display screen or a projector, for example. The input means can be part of the display if the display is designed as a touchscreen. Otherwise, the input means is, for example, a trackpad, a mouse, a keyboard or a microphone for recognizing speech inputs. The user interface can also provide different input means.

The dialogs are components of the graphical user interface that is output on the display. Operating systems and browsers for terminal devices provide functions suitable for implementing the dialogs. Thus each dialog can be displayed, for example, in a window of its own on the user interface, in a frame of its own on a browser or in a full-screen view.

The selection elements are, for example, icons or buttons and can be actuated by a mouse-click or by tapping, for instance.

The interaction elements are, for example, widgets known from graphical user interfaces, such as input fields for numbers, drop-down list boxes, checkboxes, etc.

In the primary dialog, a user finds a work overview with familiar concepts of an application domain in the form of usage functions. This reduces the learning effort and mental strain when working on the user's task.

The use of a merely two-level dialog hierarchy is a special advantage. This supports small display screen sizes by switching between primary and secondary dialogs and can be shown in parallel on sufficiently large displays. The solution thus scales in relation to very different display screen sizes.

The merely two-level dialog hierarchy reduces the learning effort in comparison with conventional software applications for parameterizing automation units which, owing to their large scope of functions, are structured into a plurality of windows (e.g. tabs, dialogs and sub-dialogs).

This applies particularly to devices with small display screens, in which elements for navigation and orientation have to be reduced in favor of dialog contents. Differently from the prior art, the user need not develop a refined mental model of the dialog navigation for the merely two-level dialog hierarchy, and does not have to continuously orient himself during interaction with the user interface (“where am I?”, “how can I reach the appropriate dialog?”, etc.). This reduces uncertainty, errors and frustration, particularly for occasional users.

The mapping of base functions and follow-on functions by the dialogs relieves the user of the necessity to conceptually structure his task to be performed into individual work steps and transpose them onto the aspects provided by the user interface. Consequently, the user does not need to acquire detailed knowledge of the possibilities and sequences of the user interface for this translation work, as is the case with conventional applications for parameterizing automation units, which use a combination of various aspects, for example physical or logical components (e.g. sensors, gear units, error memories), hierarchical structures (e.g. construction of a machine) and tools in order to initiate a respective specific action.

According to one embodiment, the base function and the follow-on functions are defined by a functional analysis system technology of a value analysis, in particular in conformity with DIN EN 16271 and/or VDI 2800.

This offers the advantage that the dialog navigation of the system can be structured consistently on the basis of usage functions in conformity with the value analysis according to DIN EN 16271 and VDI 2800.

In one development, the base function is a start-up of the automation unit and/or a start-up of a second automation unit connected to the automation unit.

According to one embodiment, the processor is programmed to output the primary dialog and simultaneously a respective one of the secondary dialogs adjacent thereto on the display.

This embodiment is advantageous for large display screens.

In one development, the processor is programmed to output the primary dialog and the secondary dialogs alternately on the display, only one dialog being output at any time.

This development is advantageous for small display screens.

According to one embodiment, each secondary dialog provides a return element, the actuation of which effects an immediate return to the primary dialog.

This embodiment offers the advantage that the user does not have to reorient himself again and again because he returns again and again to the primary dialog when working through his task.

In one development, the processor is programmed to output a second primary dialog and multiple second secondary dialogs graphically on the display, wherein the second primary dialog maps to a second base function of the automation unit, for the performance of which the automation unit is designed, and wherein each second secondary dialog maps to a follow-on function, which is necessary for the second base function, and has interaction elements by which the automation unit can be parameterized.

Corresponding to this development, the user interface can also output primary dialogs for further base functions and secondary dialogs for the follow-on functions thereof.

The terminal device and the automation unit each have the user interface.

On the computer-readable data carrier, a computer program product (non-transitory computer readable storage medium having instructions, which when executed by a processor, perform actions which carries out the method when executed in a processor is stored.

The computer program is run in a processor and in the process carries out the method.

### BRIEF DESCRIPTION

Some of the embodiments will be described in detail, with reference to the following figures, wherein like designations denote like members, wherein:

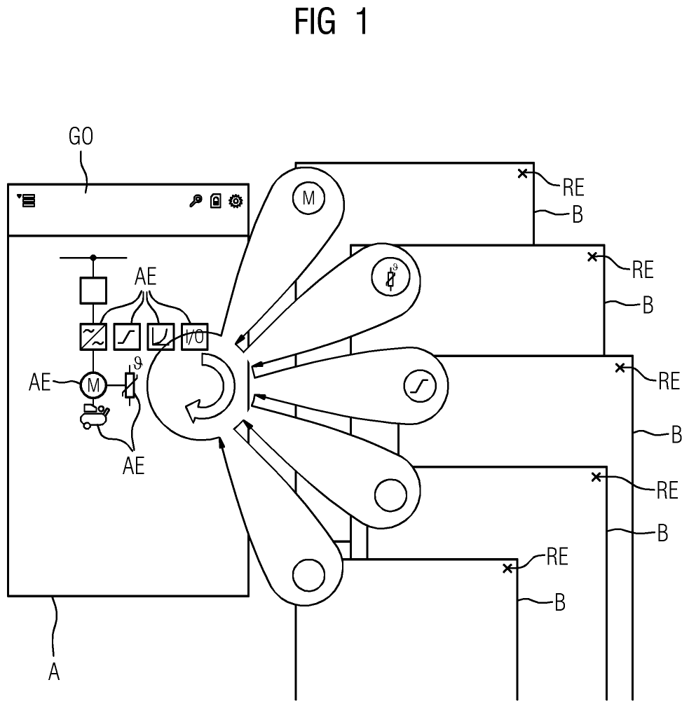

FIG. 1 shows a graphical user interface GO for parameterizing an automation unit;

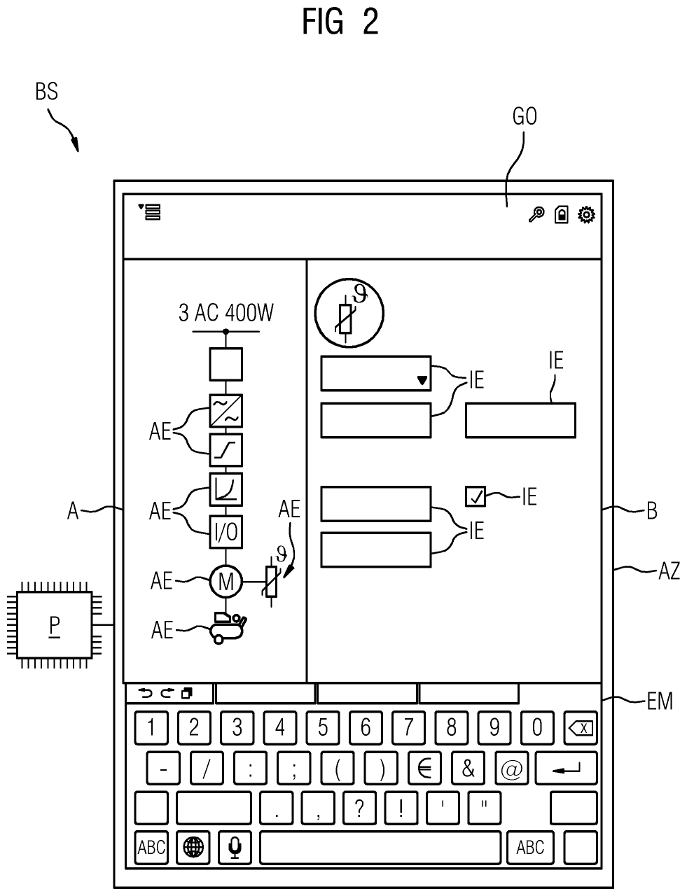

FIG. 2 shows a user interface BS for parameterizing an automation unit; and

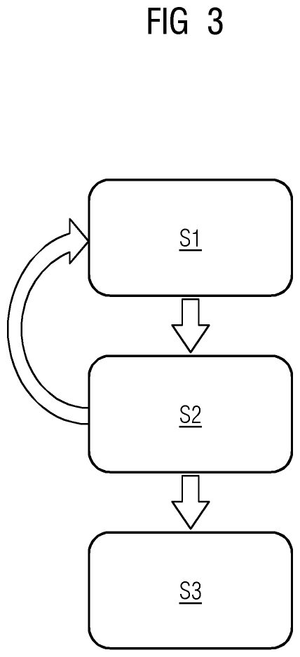

FIG. 3 shows a work sequence for parameterizing an automation unit.

### DETAILED DESCRIPTION

FIG. 1 shows a graphical user interface GO for parameterizing an automation unit. The automation unit is, for example, an automation component (such as a drive or a controller), a machine, a group of automation components or machines, or an automated plant such as a factory or a power plant. In the application case shown in FIG. 1, the automation unit is an inverter that is configured or parameterized to start up a drive. This parameterization for starting up the drive is an overall function or base function of the automation unit in the sense of a value analysis. For example, the base functions of the automation unit have been defined beforehand by a functional analysis system technology of a value analysis in conformity with DIN EN 16271 and/or VDI 2800. Such definitions of base functions and follow-on functions, as well as the determination thereof by means of the functional analysis system technology of the value analysis, are known to a person skilled in the art from, for example, “Wertanalyse—das Tool im Value Management”, VDI—Gesellschaft Produkt—and Prozessgestaltung (publisher), 6th edition, Springer-Verlag, 2011, p. 63 ff.

Precisely one primary dialog A on the graphical user interface GO maps to said base function (starting up a drive) of the automation unit. For this purpose, the graphical user interface GO provides, for example, a tab with the name of the base function, by selecting which the primary dialog A can be displayed on the graphical user interface GO. Further tabs can provide further base functions of the automation unit having primary dialogs of their own, for example for the base functions “configure” and “optimize”.

The primary dialog A is already shown on the graphical user interface GO in FIG. 1. From top to bottom, it illustrates a logical view of the base function that it maps to, in this case the setting up of a drive, beginning with basic data of a power supply, followed by a sine wave filter and a line with four selection elements AE, with which the inverter itself can be parameterized. This is then followed by a line with two selection elements AE, via which data of the drive to which the inverter is connected can be captured. The selection elements AE are, for example, icons or buttons and can be actuated by a mouse-click or by tapping, for instance.

By actuating any of the selection elements AE, a user directly reaches an associated secondary dialog B from a plurality of secondary dialogs B. In the exemplary embodiment having a small display screen as shown in FIG. 1, the selected secondary dialog B appears on the graphical user interface GO in place of the primary dialog A.

Each of these secondary dialogs B completely maps to a follow-on function that is necessary for performing the base function. The names of these follow-on functions or secondary dialogs B in the present exemplary embodiment are for example “configure drive”, “monitor motor temperature”, “determine drive kinematics”, “configure PLC communication” etc. The follow-on functions or secondary dialogs are thus identified by a tuple formed from a noun and a verb in the infinitive. The follow-on functions have also been defined beforehand by a functional analysis system technology of a value analysis for example, in conformity with DIN EN 16271 and/or VDI 2800 for instance.

By actuating a return element RE, the user moves directly back to the primary dialog A, from which he can open any desired other secondary dialog B by actuating the associated selection element AE.

Every secondary dialog B contains interaction elements which the user employs to parameterize the automation unit. The respective follow-on function (i.e. “configure drive”, “determine drive kinematics”, “configure PLC communication” for example) of the selected secondary dialog B is performed thereby. As soon as the user has selected and processed all secondary dialogs B, all the follow-on functions are performed, whereby the base function is then also performed. The automation unit can be continually parameterized in this case during the processing of the secondary dialogs B, or at the end, after all inputs have been made.

The interaction elements are, for example, widgets known from graphical user interfaces, such as input fields for numbers, drop-down list boxes, checkboxes, etc.

Thus only the primary dialog A and the secondary dialogs B are used for user navigation to perform the base function. This is therefore only a two-level dialog hierarchy. In addition, temporarily opened pop-up dialogs are possible if need be, e.g. for error messages or selecting objects or files; however, these do not change the character of the two-level dialog hierarchy, which makes particularly intuitive navigation for performing the base function possible for the user.

The interaction concept described improves efficiency, effectiveness and satisfaction of the users. This is because the user finds a work overview in the primary dialog A, comprising familiar concepts of an application domain in the form of usage functions (the individual follow-on functions for performing the base function). This reduces the learning effort and mental strain when working on the user's task. Furthermore, the user does not have to reorient himself again and again because he returns again and again to the primary dialog A when working through his task. Because the displayed selection elements AE are in the nature of offerings, they support action planning by the user for subsequent work steps.

FIG. 2 shows, by way of example, a user interface BS having a display AZ for parameterizing an automation unit. While the exemplary embodiment described in the context of FIG. 1 is designed for a small display screen, on which the primary dialog A and the secondary dialogs B are displayed alternately, the display AZ in the exemplary embodiment shown in FIG. 2 allows the primary dialog A and respectively one of the secondary dialogs B to be displayed side-by-side. Differently from FIG. 1, the selection elements AE of the primary dialog A are now arranged in a column. By actuating the selection elements AE, the user can show any desired secondary dialogs B in the right-hand part of the display AZ and can operate their interaction elements IE in order to perform the follow-on function of the respective secondary dialog. Otherwise, the explanations regarding FIG. 1 also apply analogously here.

The user employs an input means EM for his inputs. The input means can be part of the display AZ if it is designed as a touchscreen. Otherwise, the input means is, for example, a trackpad, a mouse, a keyboard or a microphone for recognizing speech inputs. The user interface BS can also provide different input means.

The outputting of the graphical interface GO and the processing of the user inputs are performed by a processor P and optionally by multiple processors such as a CPU and a GPU.

The user interface BS is part of a terminal device, for example, which runs a web client. The web client here is a browser or any desired application that can communicate with a web server run by the automation unit. The terminal device is, for example, a tablet, a smartphone, a notebook or a fixedly installed PC.

FIG. 3 shows a work sequence for parameterizing an automation unit, the description below again referencing the elements shown in FIG. 2, and building on the preceding explanations.

In a selection step S1, the processor P or a further processor detects an actuation of one of the selection elements AE by a user and outputs the selected secondary dialog B graphically. In a processing step S2, the processor P or a further processor evaluates actuations of the interaction elements IE in the selected secondary dialog B by the user and parameterizes the automation unit accordingly, whereby the follow-on function of the selected secondary dialog B is performed. The selection step S1 and the processing step S2 are repeated until all follow-on functions are performed, whereby the base function is automatically performed in a work sequence conclusion S3. To this end, the automation unit is parameterized with the parameter values set in the secondary dialogs B, unless that has already taken place in the processing steps S2. In this context, the entire data for parameterizing the automation unit can be uploaded by a web client onto a web server of the automation unit.

The previously described exemplary embodiments can also be effected by suitably programmed HTML code stored on a web server of the automation unit that is designed to communicate with a web client on a terminal device.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A user interface for parameterizing an automation unit, comprising:
a display that is designed to output a graphical user interface; and
a processor that is programmed to output a primary dialog and a plurality of secondary dialogs graphically on the display, wherein the primary dialog maps to a base function of the automation unit, for a performance of which the automation unit is designed, wherein each secondary dialog maps to a follow-on function, which is necessary for performing the base function, and has interaction elements, via which the automation unit can be parameterized, whereby the follow-on function can be performed, and wherein the primary dialog provides, for each secondary dialog, a selection element, by actuating which the respective secondary dialog can be opened directly from the primary dialog; and
at least one input means which allows an operation of the selection elements and/or the interaction elements.

2. The user interface as claimed in claim 1, wherein the base function and the follow-on functions are defined by a functional analysis system technology of a value analysis, in conformity with DIN EN 16271 and/or VDI 2800.

3. The user interface as claimed in claim 1, wherein the base function is a start-up of the automation unit and/or a start-up of a second automation unit connected to the automation unit.

4. The user interface as claimed in claim 1, wherein the processor is programmed to output the primary dialog and simultaneously a respective one of the secondary dialogs adjacent thereto on the display.

5. The user interface as claimed in claim 1, wherein the processor is programmed to output the primary dialog and the secondary dialogs alternately on the display, only one dialog being output at any time.

6. The user interface as claimed in claim 5, wherein each secondary dialog provides a return element, the actuation of which effects an immediate return to the primary dialog.

7. The user interface as claimed in claim 1,
wherein the processor is programmed to output a second primary dialog and multiple second secondary dialogs graphically on the display,
wherein the second primary dialog maps to a second base function of the automation unit, for the performance of which the automation unit is designed, and
wherein each second secondary dialog maps to a follow-on function, which is necessary for performing the second base function, and has interaction elements, via which the automation unit can be parameterized.

8. A method for parameterizing an automation unit,
outputting, by a processor, a primary dialog graphically on a display, wherein the primary dialog maps to a base function of the automation unit, for the performance of which the automation unit is designed, wherein the primary dialog provides, for each secondary dialog from a plurality of secondary dialogs, a selection element, by actuating which the respective secondary dialog can be opened directly from the primary dialog, and wherein each secondary dialog maps to a follow-on function that is necessary for performing the base function,
in a selection step, detecting, by the processor or a further processor, an actuation of one of the selection elements by a user and outputting the selected secondary dialog graphically on the display,
in a processing step, evaluating, by the processor or the further processor, actuations of interaction elements in the selected secondary dialog by the user and parameterizing the automation unit accordingly, whereby the follow-on function of the selected secondary dialog is performed, and
wherein the selection step and the processing step are repeated until all follow-on functions are performed, whereby the base function is performed.

9. The method as claimed in claim 8, wherein the base function and the follow-on functions are defined by a functional analysis system technology of a value analysis, in conformity with DIN EN 16271 and/or VDI 2800.

10. The method as claimed in claim 8, wherein the base function is a start-up of the automation unit and/or a start-up of a second automation unit connected to the automation unit.

11. The method as claimed in claim 8, wherein the processor outputs the primary dialog and simultaneously a respective one of the secondary dialogs adjacent thereto on the display.

12. The method as claimed in claim 8, wherein the processor outputs the primary dialog and the secondary dialogs alternately on the display, only one dialog being output at any time.

13. The method as claimed in claim 12, wherein each secondary dialog provides a return element, the actuation of which effects an immediate return to the primary dialog.

14. An HTML code for parameterizing an automation unit,
suitable for storage on a web server on the automation unit that is designed to communicate with a web client on a terminal device, and suitable for execution in the web client,
designed to output a primary dialog and multiple secondary dialogs graphically on a display of the terminal device,
wherein the primary dialog maps to a base function of the automation unit, for the performance of which the automation unit is designed, and
wherein each secondary dialog maps to a follow-on function, which is necessary for performing the base function, and has interaction elements, via which the automation unit can be parameterized, whereby the follow-on function can be performed, and
wherein the primary dialog provides, for each secondary dialog, a selection element by actuating which the respective secondary dialog can be opened directly from the primary dialog.

15. A terminal device,
comprising the user interface as claimed in claim 1.

16. An automation unit,
comprising the user interface as claimed in claim 1.

17. A computer-readable data carrier,
on which a computer program product, comprising a computer readable hardware storage device having computer readable program code stored therein, said program code executable by a processor of a computer system to implement a method as claimed in claim 8 when it is executed in the processor.

18. A computer program, which is executed in a processor and in the process carries out the method as claimed in claim 8.
